(19) United States
(12) Patent Application Publication
(10) Pub. No.: US 2006/0247024 A1
(43) Pub. Date: Nov. 2, 2006

(54) Gaming machine

(75) Inventors: Kazunobu Sato, Tokyo (JP); Shinji Hara, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP

(21) Appl. No.: 11/411,134

(22) Filed: Apr. 26, 2006

(30) Foreign Application Priority Data
Apr. 28, 2005 (JP) 2005-132967

(51) Int. Cl. A63F 13/00

(52) U.S. Cl. 463/25

(57) ABSTRACT

A gaming machine offers a base game and a bonus game, and has a display unit and a processor for controlling the gaming machine. The processor controls the display unit so that the display unit displays selection images at a time after determining that the base game should shift into the bonus game and before the bonus game is started. The processor changes any of the selection images into a corresponding image which corresponds with the selection image in accordance with an input made by a player. The processor determines an execution condition of the bonus game based on displayed corresponding images.

### CROSS REFERENCE TO RELATED APPLICATION

This application is based upon and claims the benefit of priority from the prior Japanese Patent Application No. 2005-132967, filed on Apr. 28, 2005, the entire contents of which are incorporated herein by reference.

### BACKGROUND OF THE INVENTION

1. Field of the Invention

The present invention relates to a gaming machine that offers a base game and a bonus game which is advantageous to a player.

2. Description of Related Art

Known is a gaming machine that offers not only a base game but also a bonus game (see Japanese Patent Unexamined Publication Nos. 11-244453 and 2003-62177). When the base game is played in this kind of gaming machine, reels on each of which symbols are arranged are mechanically rotated thus variably displaying the symbols, or alternatively images of reels each having symbols thereon are displayed in a scrolling manner. Which symbols or images of symbols will be displayed when the reels are stopped is determined by lottery. Based on a lottery result, game media such as coins or medals are paid out or the base game shifts into the bonus game.

### SUMMARY OF THE INVENTION

The bonus game is basically more advantageous to a player than the base game is. Accordingly, many players expect that game media lost in the base game will be recovered in the bonus game. For these players, under what execution condition the bonus game is played, e.g., which percentage of payout or which number of free games (here, the free game means a game playable without inserting any game medium) is given in the bonus game, is a very significant matter. Therefore, these players pay great attention to advantageousness and disadvantageousness of such an execution condition of the bonus game when they play games or select gaming machines.

In this respect, however, the execution condition of the bonus game is automatically determined based on a result of a lottery which is executed at the time when a shift to the bonus game is allowed. Therefore, the players can do nothing but hope that they can play a bonus game on, even a little, more advantageous condition. Once the base game has shifted into the bonus game, the players inertially play games and the games are apt to lose their attraction to the players.

An object of the present invention is to provide a gaming machine that offers a base game and a bonus game which is advantageous to a player, wherein a player's interest in the execution condition of the bonus game can be increased and at the same time a game can be more attractive to a player.

According to an aspect of the present invention, there is provided a gaming machine comprising a display unit and a processor for controlling the gaming machine. The processor determines whether a base game should shift into a bonus game. The processor shifts the base game into the bonus game when having determined that the base game should shift into the bonus game. The processor controls the display unit so that the display unit displays a plurality of selection images at a time after determining that the base game should shift into the bonus game and before the bonus game is started. The processor receives an input made by a player after the display unit displays the selection images. The processor changes any of the selection images which are displayed on the display unit into a corresponding image which corresponds with the selection image in accordance with the input thus received. The processor determines, based on a plurality of the corresponding images which are displayed on the display unit, an execution condition of the bonus game.

In this aspect, any of the selection images is changed into a corresponding image in accordance with an input made by a player, and the execution condition of the bonus game is determined based on corresponding images displayed on the display unit. That is, the execution condition of the bonus game changes depending on an input made by a player. Accordingly, the player can actively participate in determination of the execution condition of the bonus game, and therefore his/her interest in the execution condition can be increased. In addition, since the execution condition of the bonus game is determined based on two or more corresponding images displayed on the display unit, variation can be added to determination of the execution condition, as compared with a case where the execution condition is determined based on a single corresponding image displayed. Moreover, a player can make an input but cannot predict the execution condition to be determined, which enhances a game feeling. This makes a game more attractive to the player.

### BRIEF DESCRIPTION OF THE DRAWINGS

Other and further objects, features and advantages of the invention will appear more fully from the following description taken in connection with the accompanying drawings in which:

FIG. 1 is a perspective view of a slot machine according to an embodiment of the present invention;

FIG. 2 is a block diagram showing an electrical construction of the slot machine of FIG. 1;

FIG. 3 is a block diagram detailing an image control circuit shown in FIG. 2;

FIG. 4 is a flowchart of a main processing which is executed in the slot machine of FIG. 1 from beginning to end of a game;

FIG. 5 is a flowchart of a base game processing;

FIG. 6 is a flowchart of a bonus game processing;

FIG. 7 is a flowchart of a sub game processing;

FIG. 8 shows an exemplary image that is displayed on a main display;

FIG. 9 shows, as an example, that the main display displays images of back sides of cards;

FIG. 10 shows a state where some of the images of back sides of cards shown in FIG. 9 have been changed into images of front sides;

FIG. 11 shows an exemplary stopped-symbol determination table;

FIG. 12 shows an exemplary front-image determination table;

FIG. 13 shows an exemplary execution-condition determination table;

FIG. 14 shows another exemplary front-image determination table;

FIG. 15A shows, as another example, that the main display displays images of back sides of cards; and

FIG. 15B shows a state where some of the images of back sides of cards shown in FIG. 15A have been changed into images of front sides.

### DESCRIPTION OF THE PREFERRED EMBODIMENTS

In the following, a certain preferred embodiment of the present invention will be described with reference to the accompanying drawings.

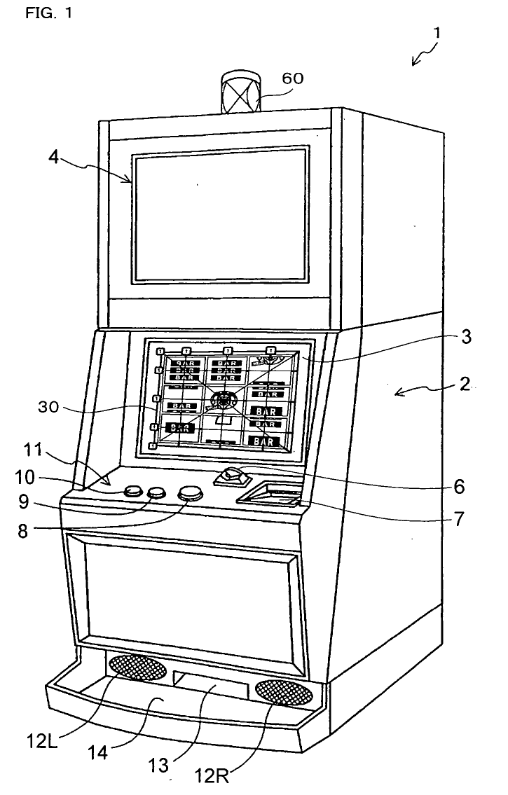

First, with reference to FIG. 1, a description will be given to a general construction of a slot machine 1 according to an embodiment of the present invention. In the slot machine 1, images of reels each having symbols thereon are displayed in a scrolling manner, so that a game (which is called a slot game) is given. The slot machine 1 offers not only a base game mode but also a bonus game mode. In the base game mode, a base game, which is started at the beginning of a game, is played. In the bonus game mode, a bonus game, which follows the base game under a certain condition, is played. In the bonus game mode as well as in the base game mode, images of reels are displayed in a scrolling manner, so that a game is given.

The slot machine 1 includes a main display 3 and a sub display 4. The main display 3 is placed on a front face of a cabinet 2, and has a liquid crystal display device. The sub display 4 is placed on the upper side of the main display 3, and has a liquid crystal display device, too.

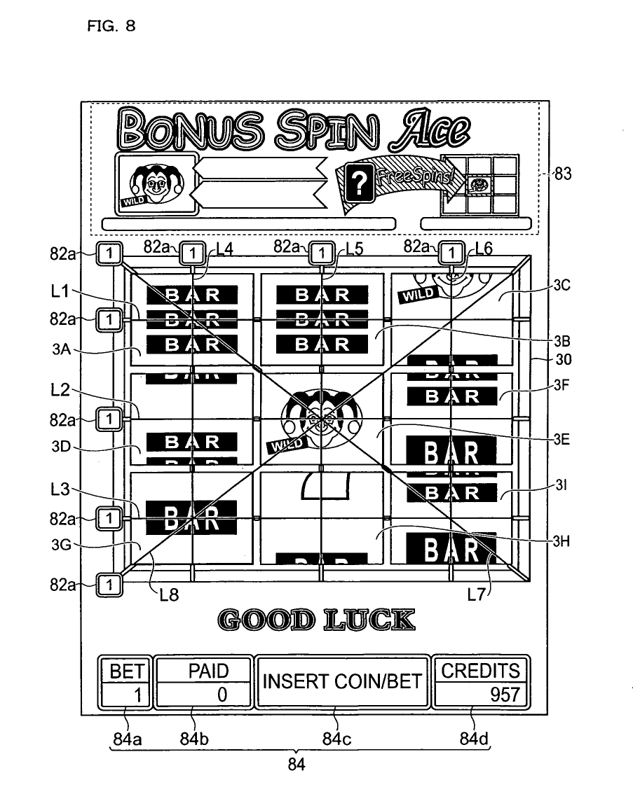

The main display 3 functions as a “display unit” of the present invention. A variable display area 30 is provided substantially at a center of the main display 3. The variable display area 30 has a total of nine variable display portions 3A, 3B, 3C, 3D, 3E, 3F, 3G, 3H, and 3I, which form three vertical rows and three horizontal rows (see FIG. 8). Both in the base game mode and in the bonus game mode, that is, both in a base game and in a bonus game, each of the variable display portions 3A to 3I in the variable display area 30 displays an image of a reel, which is scrolling as if a mechanical reel is rotating therein, so that symbols travel from top to down. The variable display area 30 also has a total of eight pay lines L1 to L8, each of which passes through three of the variable display portions 3A to 3I. The eight pay lines L1 to L8 include ones which correspond to the three vertical rows and three horizontal rows, and ones which correspond to diagonal lines.

The sub display 4 displays an image relating to a game such as a payout table and a description of a game.

A control panel 11 which is substantially horizontal is placed on the lower side of the main display 3. The control panel 11 has a coin insertion slot 6, a bill insertion slot 7, a spin switch 8, a 1-BET switch 9, and a maximum BET switch 10.

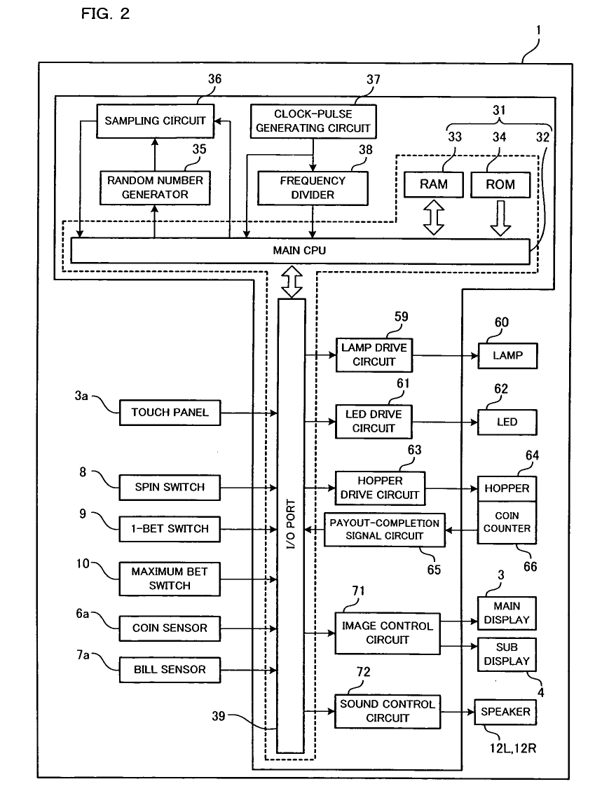

A game medium such as a coin or a medal (hereinafter referred to as a “coin”) is inserted into the coin insertion slot 6, and a bill is inserted into the bill insertion slot 7. A coin sensor 6a that detects a coin and a bill sensor 7a that detects a bill are provided in the coin insertion slot 6 and the bill insertion slot 7, respectively (see FIG. 2). By pressing the spin switch 8, a slot game is started so that images of reels are displayed in a scrolling manner in the respective variable display portions 3A to 3I. By pressing the 1-BET switch 9 once, one coin is betted. By pressing the maximum BET switch 10, a maximum number of coins bettable per game are betted.

The cabinet 2 has, in its bottom part, a coin payout opening 13 and a coin tray 14 that receives coins paid out through the payout opening 13. Speakers 12L and 12R are provided on right and left sides of the payout opening 13.

Next, an electrical construction of the slot machine 1 will be described with reference to FIG. 2.

A core of the electrical construction of the slot machine 1 is a microcomputer 31 including a main CPU (Central Processing Unit) 32, a RAM (Random Access Memory) 33, and a ROM (Read Only Memory) 34. The main CPU 32 inputs/outputs a signal to/from other components through an I/O port 39, and controls an operation of the whole slot machine 1 in accordance with a program stored in the ROM 34. The RAM 33 stores therein data and programs used by the main CPU 32. For example, after a game is started, the RAM 33 temporarily stores therein a random number which is sampled by a later-described sampling circuit 36. The ROM 34 stores therein programs executed by the main CPU 32, permanent data, and the like.

The slot machine 1 has a random number generator 35, a sampling circuit 36, a clock-pulse generating circuit 37, and a frequency divider 38. In accordance with a command from the main CPU 32, the random number generator 35 generates a certain range of random numbers. In accordance with a command from the main CPU 32, the sampling circuit 36 samples arbitrary one out of the random numbers generated by the random number generator 35, and then outputs the sampled random number to the main CPU 32. The clock-pulse generating circuit 37 generates a reference clock used for an operation of the main CPU 32. The frequency divider 38 inputs to the main CPU 32 a signal obtained by dividing the reference clock by a constant period.

The slot machine 1 further includes a touch panel 3a, a lamp drive circuit 59, a lamp 60, an LED drive circuit 61, an LED 62, a hopper drive circuit 63, a hopper 64, a payout-completion signal circuit 65, a coin counter 66, an image control circuit 71, and a sound control circuit 72.

The touch panel 3a is provided so as to cover a display screen of the main display 3. The touch panel 3a detects a position where a player's finger or the like touches, and outputs to the main CPU 32 a position signal that corresponds to the detected position. The lamp drive circuit 59 outputs to the lamp 60 a signal for lighting the lamp 60 (see FIG. 1), so that the lamp 60 flashes during a game. This flashing serves as an effect for the game. The LED drive circuit 61 controls a flashing display of the LED 62. The LED 62 serves to display the number of credits and the number of acquisition, etc.

The hopper drive circuit 63 drives the hopper 64 in accordance with a controlling made by the main CPU 32. The hopper 64 causes a coin to be paid out through the payout opening 13 into the coin tray 14. The coin counter 66 counts coins which are paid out by the hopper 64, and outputs data about the number of coins to the payout-completion signal circuit 65. When the number of coins, the data of which are outputted from the coin counter 66, reaches a predetermined value, the payout-completion signal circuit 65 outputs to the main CPU 32 a signal for notifying that payout of coins has been completed.

The image control circuit 71 controls image displays on the respective main and sub displays 3 and 4 so that the main and sub displays 3 and 4 displays various images, which include the images of reels each having symbols thereon.

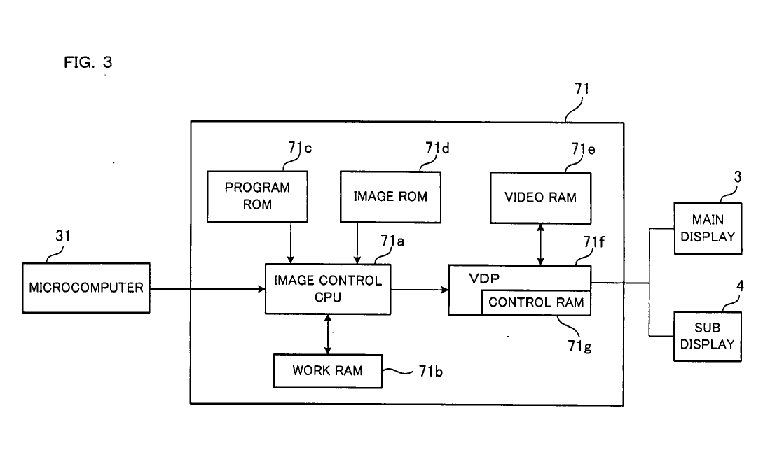

As shown in FIG. 3, the image control circuit 71 has an image control CPU 71a, a work RAM 71b, a program ROM 71c, an image ROM 71d, a video RAM 71e, and a VDP (Video Display Processor) 71f. Based on a parameter defined by the microcomputer 31, and in accordance with an image control program concerning displays on the main and sub displays 3 and 4 which is stored in the program ROM 71c, the image control CPU 71a determines images, such as images of reels and images of symbols that are displayed when the reels are stopped, which will be displayed on the respective main and sub displays 3 and 4. The work RAM 71b functions as a temporary storage which is used when the image control CPU 71a executes the image control program.

The program ROM 71c stores therein the image control program, various selection tables, and the like. The image ROM 71d stores therein dot data for forming images. The dot data include image data for symbols which are used in the base game and the bonus game. The video RAM 71e functions as a temporary storage which is used when the VDP 71f forms images. The VDP 71f, which includes a control RAM 71g, forms images reflecting the display contents of the main and sub displays 3 and 4 which have been determined by the image control CPU 71a, and then outputs the image thus formed to the respective main and sub displays 4.

Referring to FIG. 2 again, the sound control circuit 72 outputs to the speakers 12L and 12R a sound signal for outputting a sound from the speakers 12 L and 12R. For example, in an appropriate time after a game is started, a sound for enhancing amusement of the game is outputted from the speakers 12L and 12R.

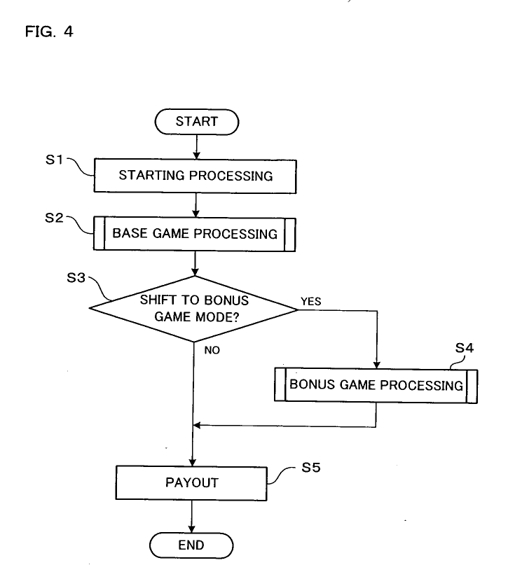

Next, an operation of the slot machine 1 will be described with reference to flowcharts shown in FIGS. 4 to 7. In FIGS. 4 to 7 and in the following description, a step is abbreviated as “S”. In the slot machine 1, the main CPU 32 controls a progress of a game.

In the main processing shown in FIG. 4, the slot machine 1 first executes a starting processing (S1). Then, in the base game mode, a base game processing is executed (S2), and subsequently the processing proceeds to S3. In S3, whether the game mode should shift to the bonus game mode or not is determined. When it is determined that the game mode should shift to the bonus game mode (S3: YES), a bonus game processing is executed (S4). S4 is followed by S5. When it is determined that the game mode should not shift to the bonus game mode (S3: NO), the processing does not go to S4 but to S5. In S5, coins, the number of which depends on a winning combination, are paid out. After S5, the main processing is completed.

S1 to S5 will be described in more detail below.

In S1, in accordance with a controlling made by the main CPU 32, the slot machine 1 receives a game-starting operation by a player. The slot machine 1 is a gaming machine of coin-insertion type. That is, in starting a game, a player inserts a coin into the coin insertion slot 6, or alternatively presses the 1-BET switch 9 or the maximum BET switch 10 when a credit is left. Then, he/she presses the spin switch 8. Hereinafter, these operations for starting a game will be referred to as a “starting operation”. Upon the starting operation, a start signal is outputted from the spin switch 8 to the main CPU 32.

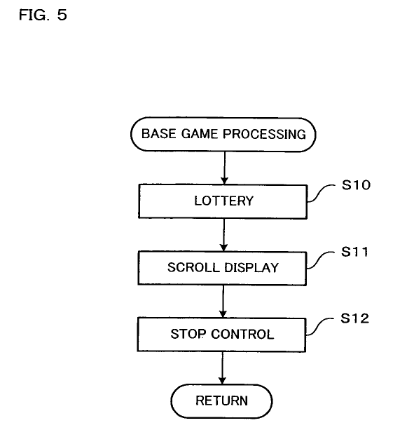

In S2, the base game processing is executed in accordance with the flowchart shown in FIG. 5. In the base game processing, first, a lottery is executed (S10) In the lottery, the main CPU 32 determines stopped symbols which are symbols displayed in the respective variable display portions 3A to 3I when the reels are stopped. In the slot machine 1, during the lottery being executed in S10, the main CPU 32 commands the image control circuit 71 to display an effect image on the sub display 4.

Here, a specific description will be given to the lottery in S10.

First, the main CPU 32 commands the random number generator 35 to generate a certain range of random numbers, and then commands the sampling circuit 36 to sample an arbitrary one out of the random numbers generated by the random number generator 35. The main CPU 32 refers to a symbol-code determination table (not shown) in order to acquire a symbol code which is associated with the sampled random number. The symbol-code determination table is stored in the ROM 34, and stores therein symbol codes associated with respective random numbers.

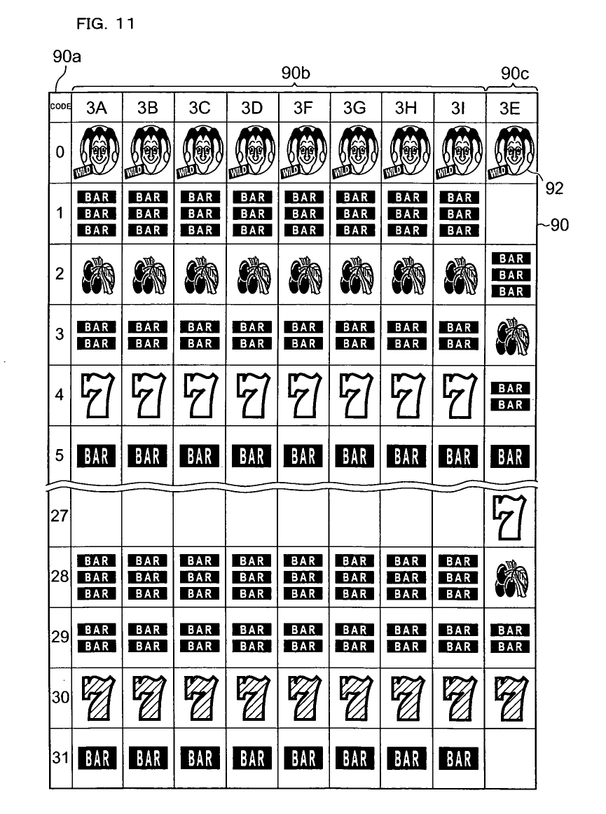

The main CPU 32 uses the acquired symbol code as a search key in referring to a stopped-symbol determination table 90 (see FIG. 11) which is stored in the ROM 34, to thereby determine which symbol will be stopped in each of the variable display portions 3A to 3I. The stopped-symbol determination table 90 is a table having a code area 90a, a first symbol area 90b, and a second symbol area 90c. The code area 90a stores therein symbol codes. The first and second symbol areas 90b and 90c store therein symbols which are associated with the respective codes.

In the first and second symbol areas 90b and 90c, codes of symbols corresponding to code numbers “0” to “31” are registered. Registered in the first symbol area 90b are codes of symbols which will be stopped in the variable display portions 3A to 3D and 3F to 3I. Registered in the second symbol area 90c are codes of symbols which will be stopped in the central variable display portion 3E. In this embodiment, a Wild Joker 92 that locates in the second symbol area 90c and corresponds to the code number “0” is a symbol having an advantage over other symbols and having an image of a human face and a character string of “WILD” in combination, as shown in FIG. 11.

A set of the above-described sampling of a random number, reference to the symbol-code determination table, and reference to the stopped-symbol determination table is performed once for each of the variable display portions 3A to 3I, that is, it is performed nine times in total. As a result, which symbols will be stopped in the respective variable display portions 3A to 3I is determined.

After which symbols will be stopped in the respective variable display portions 3A to 3I is determined, the main CPU 32 refers to a winning determination table (not shown) which is stored in the ROM 34, in order to determine whether a winning is made or not. The winning determination table stores therein combinations of codes (hereinafter referred to as “code patterns”) each associated with either one of “win” and “no win”. The main CPU 32 refers to the winning determination table using, as a search key, a code pattern of the stopped symbols which have been determined in the aforementioned manner, to thereby determine whether a winning is made or not.

Subsequently, the main CPU 32 refers to a payout determination table (not shown) which is stored in the ROM 34, to determine a payout number for a winning combination made. The payout determination table stores therein payout numbers each associated with each of winning code patterns. After a payout number is determined, the lottery in S10 ends. Then, referring to FIG. 5 again, images of reels are displayed in a scrolling manner (S11).

In S11, the main display 3 displays an image as shown in FIG. 8. At this time, nine variable display portions 3A to 3I are displayed in the variable display area 30 which locates substantially at the center of the main display 3. A title indicator 83 including a character string of “BONUS SPIN” and a description of game contents is provided on the upper side of the variable display area 30. An indicator 84 including a total BET number indicator 84a, a PAID number indicator 84b, an “INSERT COIN/BET” indicator 84c, and a CREDIT number indicator 84d is provided on the lower side of the variable display area 30. BET number indicators 82a, each of which indicates a BET number for each of the eight pay lines L1 to L8, are provided so as to surround the variable display portions 3A to 3I.

Upon a start of a game, in accordance with a command from the main CPU 32, the images of reels are scrolled in the respective variable display portions 3A to 3I.

Then, a stop control is operated (S12). More specifically, a speed of scrolling is slowed down, and the stopped symbols which have been determined based on a result of the lottery in S10 are displayed in the variable display portions 3A to 3I. Then, the base game processing ends.

Referring to FIG. 4 again, in S3, the main CPU 32 determines whether a game mode should shift from the base game mode to the bonus game mode or not based on the result of the lottery in S10 which has been executed in the base game processing S2 and in accordance with a shifting condition for shifting from the base game mode to the bonus game mode. In this embodiment, the shifting condition is that a symbol stopped in the variable display portion 3E is a Wild Joker 92. When the shifting condition is satisfied, it is determined that the game mode should shift to the bonus game mode. The shifting condition can be set variously and may be that a predetermined combination of symbols is displayed.

When it is determined that the game mode should shift to the bonus game mode (S3: YES), the main display 3 displays the Wild Joker 92 as a symbol stopped in the variable display portion 3E and a message of “GET THE SPECIAL BONUS!!”, for example. Then, the main CPU 32 shifts the game mode to the bonus game mode in which the bonus game processing is then performed (S4).

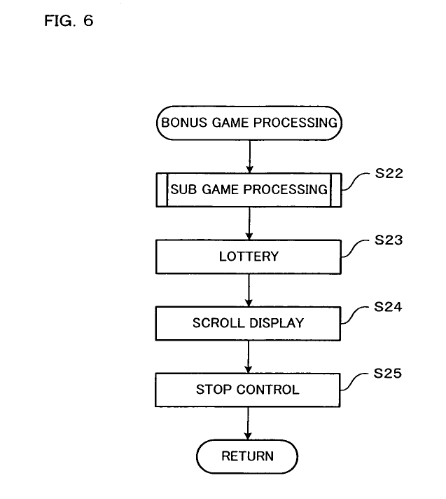

In S4, the bonus game processing is executed in accordance with the flowchart shown in FIG. 6. First, the main CPU 32 executes a sub game processing which will be described later (S22).

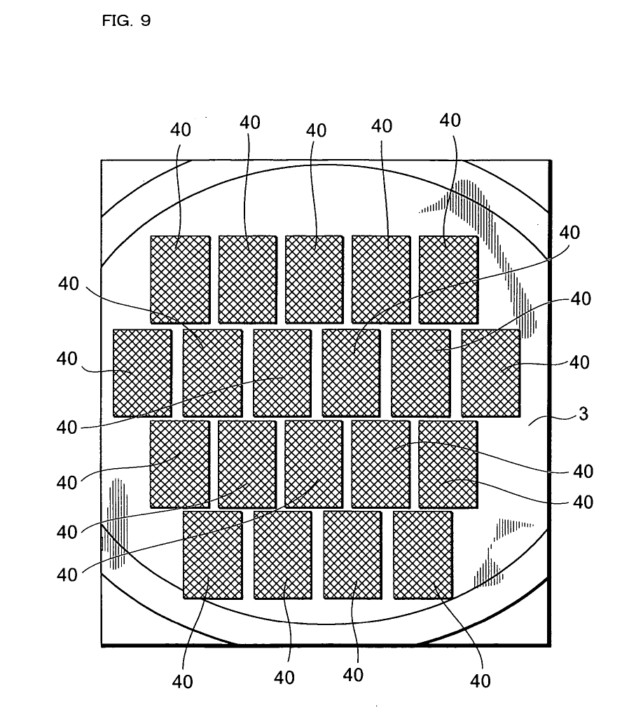

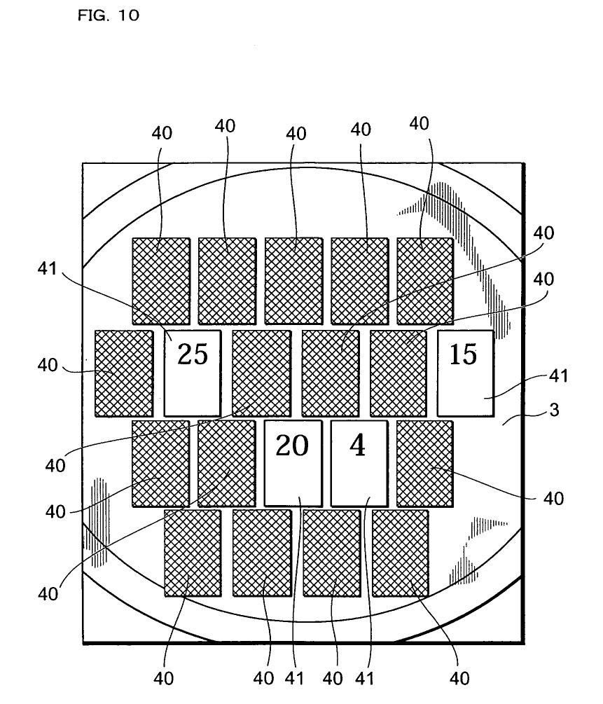

The sub game processing is executed at the time after the main CPU 32 determines that the game mode should shift from the base game mode to the bonus game mode and before the bonus game is started in the bonus game mode. The sub game processing is executed for the purpose of giving an auxiliary game by which an execution condition of the bonus game is determined. In this embodiment, for example, the execution condition of the bonus game means the number of free games. In the sub game processing, as shown in FIG. 9, images of back sides of cards (hereinafter referred to simply as “back images”) 40 are displayed on the main display 3. When a player selects any of the back images 40, the selected back image 40 is changed into an image of a front side of a card (hereinafter referred to simply as a “front image”) 41 on which the number of free games given is indicated, as shown in FIG. 10. When a pair of front images 41 having the same contents is displayed, the number of free games indicated on the pair of front images 41 is determined as the execution condition of the bonus game.

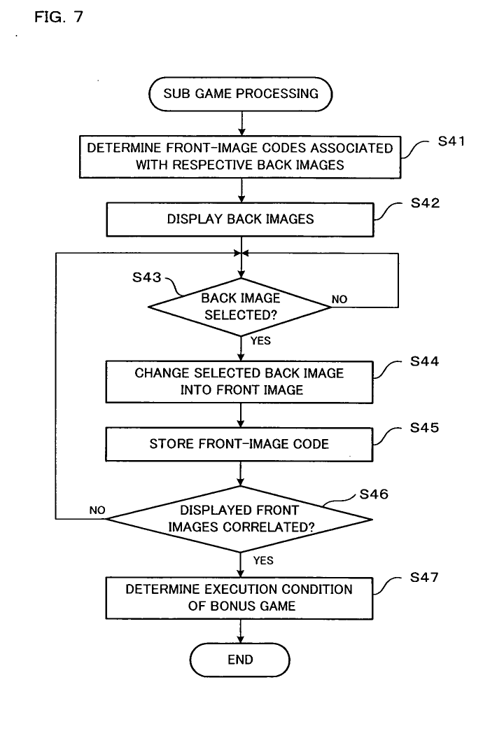

In the following, the sub game processing will be described along with the flowchart shown in FIG. 7.

First, the main CPU 32 determines front-image codes that are associated with the respective back images 40 (S41). Each of the back images 40 has its own identification number. Based on the identification number of each back image 40 and a random number sampled by the sampling circuit 36, the main CPU 32 determines front-image codes associated with the respective back image 40. The front-image code is numeric data such as 1, 3, 5, 10, 15, 20, 25, etc., and serves as a determinant of the number of free games as the execution condition of the bonus game.

After S41, the main CPU 32 displays the back images 40 on the main display 3 (S42). The back images 40 correspond to “selection images” of the present invention. All the back images 40 have the same color and the same design, and therefore a player visually sees all of them as the same objects.

After S42, the main CPU 32 determines whether a player has selected any of the back images 40 or not (S43). At this time, the touch panel 3a receives an input made by a player for a section of a back image 40. The touch panel 3a stays waiting until a player makes an input, that is, until a player touches the touch panel 3a. When a player selects a desired back image 40 by touching where the back image 40 is located with his/her finger or the like (S43: YES), the touch panel 3a outputs to the main CPU 32 a position signal that corresponds to the touched position.

After S43, the main CPU 32 changes, in accordance with the position signal received from the touch panel 3a, the selected back image 40 into a front image 41 which corresponds with the selected back image 40 (S44).

In S44, based on the position signal received from the touch panel 3a, the main CPU 32 identifies which back image 40 has been selected. Then, the main CPU 32 acquires, among the front-image codes associated with the respective back images as determined in S41, a front-image code associated with the selected back image.

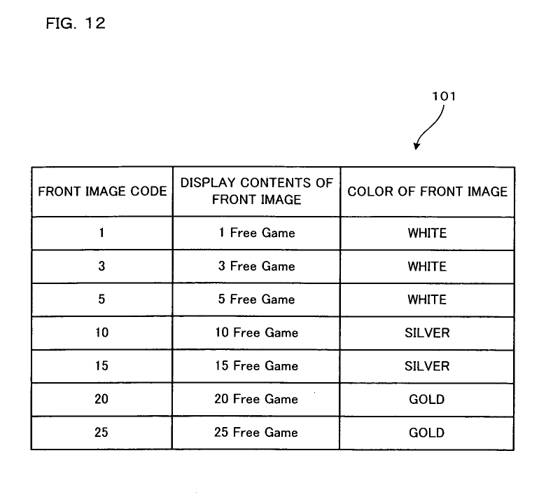

The main CPU 32 then refers to a front-image determination table 101 (see FIG. 12) which is stored in the ROM 34, and determines a front image 41 that corresponds with the acquired front-image code. The front-image determination table 101 stores therein display contents and colors of front images 41 that correspond with the respective front-image codes. For example, when the front-image code is “1”, a corresponding front image 41 is one indicated with “1 Free Game”, and when the front-image code is “3”, a corresponding front image 41 is one indicated with “3 Free Game”. Like this, the front-image code number is identical to the number of free games which is indicated on a corresponding front image 41.

The main CPU 32 commands the image control circuit 71 to generate an image that reflects display contents and a color of a front image 41 which has been determined in the above-described manner. Then, the main CPU 32 controls the main display 3 so that the main display 3 displays the generated image at a position where the selected back image 40 is located. The front image 41 thus displayed corresponds to a “corresponding image” of the present invention.

The number of free games given, which is an example of the execution condition of the bonus game, is indicated on the front image 41. The front images 41 are classified by color such that each execution condition and its advantage level can be associated with each other. To be more specific, when the number of free games given is 1, 3, or 5 the front image 41 is white colored, when the number of free games given is 10 or 15 the front image 41 is silver colored, and when the number of free games given is 20 or 25 the front image 41 is gold colored.

After S44, the main CPU 32 stores into the RAM 33 the front-image code that is associated with the selected back image (S45).

After S45, the main CPU 32 determines whether front images 41 displayed on the main display 3 are correlated or not (S46). In this embodiment, when a pair of front images 41 having the same contents is displayed on the main display 3, the main CPU 32 determines that correlation is achieved.

In S46, the main CPU 32 first determines whether two or more front-image codes are stored in the RAM 33 or not. When two or more front-image codes are not stored, it is determined that the correlation is not achieved (S46: NO), and the processing returns to S43.

When two or more front-image codes are stored in the RAM 33, the main CPU 32 then determines whether there are identical ones among those front-image codes or not. When there are identical front-image codes, it is determined that the front images 41 corresponding to the identical front-image codes are correlated (S46: YES). Thus, the identical front-image code is, as a condition-maker code, stored into the RAM 33, and the processing proceeds to S47. When there is no identical front-image code, it is determined that the displayed front images 41 have no correlation (S46: NO), and the processing returns to S43.

In this manner, the back images 40 are selected and the front images 41 are displayed one by one. S43 to S46 are repeated until a pair of front images 41 having the same contents is displayed.

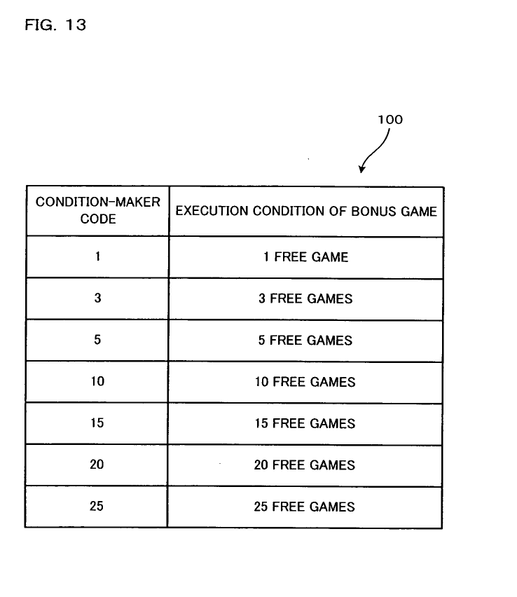

In S47, the main CPU 32 determines the execution condition of the bonus game, that is, the number of free games given. Here, the main CPU 32 refers to an execution-condition determination table 100 shown in FIG. 13, using as a search key the condition-maker code that was stored in the RAM 33 in S46 so as to determine the number of free games given. The execution-condition determination table 100 stores therein execution conditions of the bonus game associated with the respective condition-maker codes. For example, when the condition-maker code stored in the RAM 33 is “5”, it is determined that five free games will be given in the bonus game.

After the sub game processing S22 is executed in this way, as shown in FIG. 6, a lottery is executed (S23). In S23, like in S10 of the base game processing described above, the main CPU 32 determines which symbol will be stopped in each of the variable display portions 3A to 3I. After S23, like in S11 of the base game processing described above, images of reels are displayed in a scrolling manner (S24). Then, like in S12 of the base game processing, a stop control is done (S25). A series of S23, S24, and S25 is a processing for giving a free game, and is executed one after another without any operation made by a player. The number of times this series is executed is the number of free games given which has been determined in the sub game processing S22. Then, the bonus game processing ends.

Referring to FIG. 4 again, in S5, when a winning has been made in the base game or the bonus game, coins the number of which depends on a winning combination are paid out. To be more specific, the main CPU 32 commands the hopper drive circuit 63 to pay out coins, so that the hopper drive circuit 63 drives the hopper 64 to pay out coins through the payout opening 13 into the coin tray 14. The coins thus paid out by the hopper 64 are counted by the coin counter 66. When the number of coins reaches a predetermined value, the payout-completion drive circuit 65 inputs a signal to the main CPU 32 so that the payout is completed.

In the slot machine 1 of this embodiment, as thus far described above, any of the back images 40 is changed into the front image 41 in accordance with an input made by a player, and the execution condition of the bonus game is determined based on the front images 41 displayed on the main display 3. That is, the execution condition of the bonus game changes depending on an input made by a player. Accordingly, the player can actively participate in determination of the execution condition of the bonus game, and therefore his/her interest in the execution condition can be increased.

Since the execution condition of the bonus game is determined based on two or more front images 41 displayed, variation can be added to determination of the execution condition, as compared with a case where the execution condition is determined based on a single front image 41 displayed.

Moreover, in the sub game processing, a player can make an input but cannot predict the execution condition to be determined, which enhances a game feeling. This makes the game more attractive to the player.

The sub game processing S22 for determining the execution condition of the bonus game is executed at the time after it is determined that the game mode should shift from the base game mode to the bonus game mode and before the bonus game is started in the bonus game mode. The sub game processing gives a player new pleasure. Thus, even after it is determined that the game mode should shift to the bonus game mode, the player does not inertially play a game but a game becomes more attractive to the player.

Since the execution condition of the bonus game changes depending on an input made by a player, the player does not so easily get tired of the bonus game. In addition, the execution condition of the bonus game is determined based on a result of the sub game processing in which a player selects a back image 41. Therefore, synergistic effect resulting from a combination of the sub game and the bonus game is expected. This can make a game still more attractive to a player.

Since a back image 40 is selected directly based on an input made by a player, the player feels satisfaction with his/her participation in determination of the execution condition of the bonus game. This can make a game still more attractive to the player.

The execution condition of the bonus game is determined only when it is determined that front images 41 displayed on the main display 3 are correlated. Thus, selecting back images 40 is repeated until it is determined that displayed front images 41 are correlated. This can provide another game feeling to a player, and thus a game becomes more attractive to a player.

A player can easily know whether there is correlation or not, because it is determined that displayed front images 41 are correlated when the displayed front images 41 are identical, to be more specific, when a pair of front images 41 having the same contents and the same color are displayed.

Since, as shown in FIG. 12, the front images 41 are colored so as to correspond with respective execution conditions of the bonus game, a player can easily know the execution condition to be determined by a color of the front images 41.

Since the execution conditions of the bonus game are indicated on the front images 41, a player can recognize the execution condition to be determined by seeing the displayed front images 41. This makes a player enjoy a bonus game with still more interest in the execution condition of the bonus game.

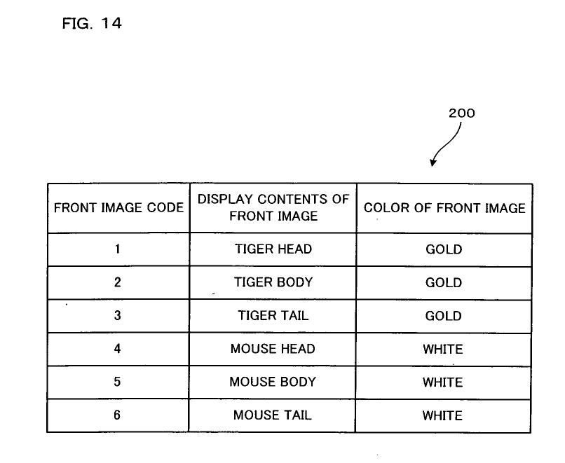

The front images 41 may be determined based on, for example, a front-image determination table 200 shown in FIG. 14 instead of the front-image determination table 101 shown in FIG. 12. In the front-image determination table 200 of FIG. 14, the front-image codes “1”, “2”, “3”, “4”, “5”, and “6” correspond to “tiger head”, “tiger body”, “tiger tail”, “mouse head”, “mouse body”, and “mouse tail”, respectively. In this case, correlation between displayed front images 41 may be achieved when a combination of the displayed front images 41 recalls a certain object in the sense of appearance, name, concept, or the like. For example, correlation may be achieved when three front images made up of tiger head, tiger body, and tiger tail are all displayed.

It may not always be necessary that correlation is achieved when a pair of front images 41 having the same contents and the same color are displayed or when a combination of three front images 41 recalls a certain object in the sense of appearance, name, concept, or the like. For example, when, among displayed front images 41 which are designed like playing cards, ones belonging to the same group such as a heart group, a spade group, etc. are displayed, correlation may be achieved irrespective of figures of the cards. In another example, correlation may be achieved when a combination of four or more front images 41 creates a predetermined appearance, name, concept, or the like. That is, correlation may be achieved when displayed front images 41 belong to the same group or when a combination of front images 41 creates a predetermined appearance, name, a concept, or the like.

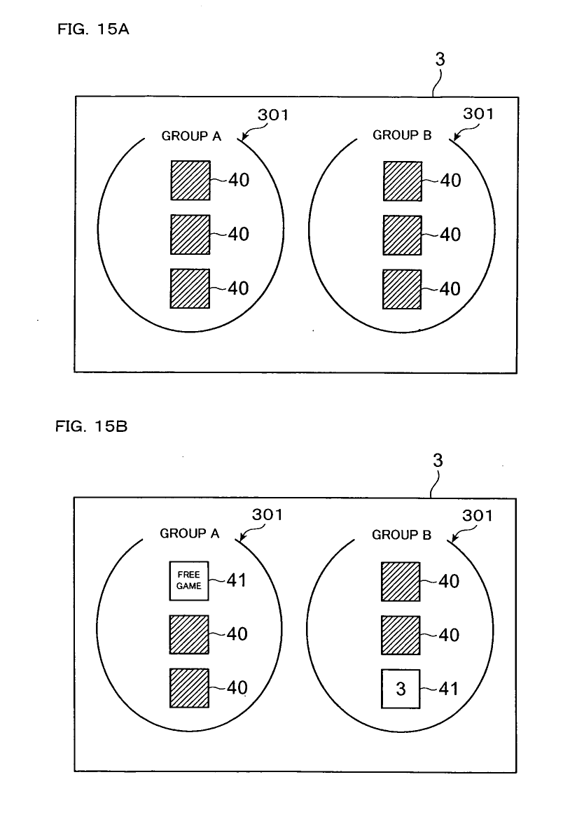

The area of the main display 3 where the back images 40 are displayed may be divided into two or more parts. For example, as shown in FIG. 15A, there may be provided two separated areas, one as a content determination area 301 and the other as a numeric element determination area 302. A player may select one back image 40 in the content determination area 301 and one back image 40 in the numeric element determination area 302, so that the execution condition of the bonus game can be determined based on a combination of a front image 41 displayed in the content determination area 301 and a front image 41 displayed in the numeric element determination area 302. For example, it may be possible that a front image 41 displayed in the content determination area 301 is indicated with “free game”, “the number of payouts”, “percentage of payout”, “the number of variable display areas”, or the like. It may be possible that a front image 41 displayed in the numeric element determination area 302 is indicated with a figure such as “2”, “3”, “5”, “10”, or the like. When, as shown in FIG. 15B, a front image 41 displayed in the content determination area 301 is indicated with “free game” and a front image 41 displayed in the numeric element determination area 302 is indicated with “3”, the execution condition of the bonus game is determined as “three free games”. When a combination of “the number of variable display areas” and “2” is made, it may be determined that two images of the variable display area 30 are displayed in a free game. In this case, the winning probability is two times higher than in the case one variable display area 30 is used.

It may not always be required that a player directly selects back images 41 by himself/herself, but it may be possible that an input by a player causes a lottery by which a back images 41 is selected.

The above-described embodiment provides nine variable display portions 3A to 3I. However, the number of variable display portions is not limited to nine, but may be three or five. Depending on the number of variable display portions, e.g., with three variable display portions, the variable display portions may be arranged in a single row.

The selection image is not limited to the back image 40 of a card, but may be, for example, an image of a closed treasure chest, a closed gate, a closed door, and the like. Also, the selection image may be an image of variably-displayed symbols. In this case, when a player selects an image of variably-displayed symbols as a selection image, the image thus selected is changed into an image of a certain stopped symbol. A combination of these images of stopped symbols may determine the execution condition of the bonus game.

In this embodiment, the execution condition of the bonus game is the number of free games given. However, this is not limitative. For example, the execution condition of the bonus game may be the number of coins paid out or the percentage of payout.

The sub game processing is not limited to the above-described one, but may be a card game similar to a concentration game.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. A gaming machine comprising a display unit and a processor for controlling the gaming machine, wherein the processor:
determines whether a base game should shift into a bonus game;
shifts the base game into the bonus game when having determined that the base game should shift into the bonus game;
controls the display unit so that the display unit displays a plurality of selection images at a time after determining that the base game should shift into the bonus game and before the bonus game is started;
receives an input made by a player after the display unit displays the selection images;
changes any of the selection images which are displayed on the display unit into a corresponding image which corresponds with the selection image in accordance with the input thus received; and
determines, based on a plurality of the corresponding images which are displayed on the display unit, an execution condition of the bonus game.

2. The gaming machine according to claim 1, wherein:
the processor receives an input which a player makes for selecting any of the selection images; and
the processor changes a plurality of the selection images which the player has selected into respective corresponding images which correspond with these selection images.

3. The gaming machine according to claim 1, wherein the processor further determines:
whether a plurality of the corresponding images displayed on the display unit are correlated or not; and
the execution condition of the bonus game based on the correlated corresponding images when having determined that the corresponding images displayed on the display unit are correlated.

4. The gaming machine according to claim 3, wherein the processor determines, when the corresponding images displayed on the display unit are identical, that the corresponding images are correlated.

5. The gaming machine according to claim 1, wherein the corresponding images are colored so as to correspond with respective execution conditions of the bonus game.

6. The gaming machine according to claim 1, wherein the execution condition of the bonus game is indicated on the corresponding image.

7. The gaming machine according to claim 1, wherein the processor:
controls the display unit so that the display unit displays the selection images in two ore more separated areas;
changes one of the selection images which are displayed in each of the separated areas into a corresponding image which corresponds with the one selection image in accordance with the input made by a player; and
determines, based on a plurality of the corresponding images which are displayed in the respective separated areas, an execution condition of the bonus game.
